(19) United States
(12) Patent Application Publication
(10) Pub. No.: US 2025/0270406 A1
(43) Pub. Date: Aug. 28, 2025

(54) COMPOSITE MEMBRANE LAYER STRUCTURE

(71) Applicant: AAC OPTICS (CHANGZHOU) CO., LTD., Changzhou (CN)

(72) Inventors: Huaiyu Chen, Changzhou (CN); Jia Wang, Changzhou (CN)

(21) Appl. No.: 18/744,733

(22) Filed: Jun. 17, 2024

Related U.S. Application Data
(63) Continuation of application No. PCT/CN2024/078873, filed on Feb. 28, 2024.

(51) Int. Cl. C09D 1/00; C09D 5/00; G02B 1/115

(52) U.S. Cl. CPC C09D 1/00; C09D 5/00; G02B 1/115

(57) ABSTRACT

The composite membrane layer structure provided by the present application includes a substrate and an intermediate layer, a first low-reflective membrane layer and a second low-reflective membrane layer sequentially coated on the substrate. An equivalent refractive index of the second low-reflective membrane layer is less than an equivalent refractive index of the first low-reflective membrane layer. An average value of reflectivity of the composite membrane layer structure is less than 0.1% in the 380-980 nm wavelength band at the angle of incidence of 0°, so that it has ultra-low reflectivity and low scattering characteristics, effectively solving the problem of fogging during actual shooting, and significantly improving the image quality.

### CROSS-REFERENCE TO RELATED APPLICATIONS

This application is a continuation of International Application No. PCT/CN2024/078873, filed Feb. 28, 2024, the entire contents of which are incorporated herein by reference.

### TECHNICAL FIELD

The present application relates to the technical field of optical lens coating, in particular to a composite membrane layer structure.

### BACKGROUND

In recent years, with the rapid development of technology, users have increasingly high requirements for the image quality captured by cameras in portable electronic devices, and the lens coating technology has continued to innovate. In the related art, new coating technology, namely aluminum oxide hydrolysis process, has been adopted in some portable electronic devices. Through this process, the coated lenses can achieve an ultra-low reflectivity of 0.1% in the visible light range, significantly improving stray light and ghosting in the images, thereby enhancing the overall image quality of the photographs. However, this process has the issue of fogging during actual shooting due to its scattering characteristics, especially when multiple lenses in a single camera module apply this technology, and the fogging issue becomes more prominent.

Therefore, it is necessary to propose a new composite membrane structure that meets the ultra-low reflectivity requirement while reducing scattering to solve the technical problem of fogging during actual shooting.

### SUMMARY

An object of the present application is to overcome the above technical problems and provide a composite membrane layer structure having low reflectivity and low scattering.

In order to achieve the above object, the present application proposes a composite membrane layer structure comprising a substrate; an intermediate layer coated on the substrate; a first low-reflective membrane layer coated on a surface of a side of the intermediate layer away from the substrate; and a second low-reflective membrane layer coated on a surface of a side of the first low-reflective membrane layer away from the intermediate layer, wherein an equivalent refractive index of the second low-reflective membrane layer is less than an equivalent refractive index of the first low-reflective membrane layer.

In an embodiment, the equivalent refractive index of the first low-reflective membrane layer is n1, and the equivalent refractive index of the second low-reflective membrane layer is n2, wherein 1.15≤n1≤1.38 and 1.05≤n2≤1.15.

In an embodiment, a thickness of the first low-reflective membrane layer and a thickness of the second low-reflective membrane layer are both 50-200 nm.

In an embodiment, the first low-reflective membrane layer and the second reflective membrane layer both comprise silica spherical particles having a diameter of 50-150 nm, wherein a diameter of the silica spherical particles in the first low-reflective membrane layer is greater than a diameter of the silica spherical particles in the second low-reflective membrane layer, and a porosity factor of the first low-reflective membrane layer is less than a porosity factor of the second low-reflective membrane layer.

In an embodiment, the substrate is a resin lens.

In an embodiment, the intermediate layer comprises at least one of Ti₃O₅, H4, Nb₂O₅, HfO₂, L5 silicon-aluminum mixture, SiO₂, MgF₂, Al₂O₃.

Compared to the related art, the composite membrane layer structure provided by the present application includes a substrate and an intermediate layer, a first low-reflective membrane layer, and a second low-reflective membrane layer sequentially coated on the substrate. An equivalent refractive index of the second low-reflective membrane layer is less than an equivalent refractive index of the first low-reflective membrane layer. An average value of reflectivity of the composite membrane layer structure is less than 0.1% in the 380-980 nm wavelength band at the angle of incidence of 0°, so that it has ultra-low reflectivity and low scattering characteristics, effectively solving the problem of fogging during actual shooting, and significantly improving the image quality.

### BRIEF DESCRIPTION OF THE DRAWINGS

In order to more clearly illustrate the technical solutions in the embodiments of the present application, the accompanying drawings that need to be used in the description of the embodiments will be briefly introduced in the following. Obviously, the accompanying drawings in the following description are only some embodiments of the present application, and for the person of ordinary skill in the field, other accompanying drawings can be obtained based on these drawings without creative labor.

FIG. 1 is a schematic diagram of a composite membrane layer structure in the present application.

FIG. 2 is a scanning electron microscope (SEM) surface morphology graph of a first low-reflective membrane layer in the composite membrane layer structure in the present application.

FIG. 3 is an SEM surface morphology graph of a membrane structure in the related art.

FIG. 4 is a graph of reflectivity data of the membrane structure at different angles of incidence in the related art.

FIG. 5 is a schematic diagram of the reflectivity of the composite membrane layer structure at different angles of incidence in the present application.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art of the present application without making creative labor fall within the protection scope of the present application.

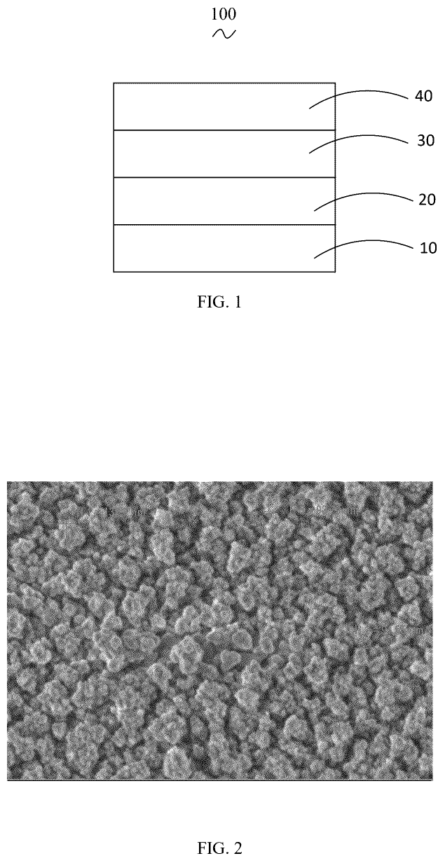

As shown in FIG. 1, the present application provides a composite membrane layer structure 100 including a substrate 10, an intermediate layer 20 coated on the substrate 10, a first low-reflective membrane layer 30 coated on a surface of a side of the intermediate layer 20 away from the substrate 10, and a second low-reflective membrane layer 40 coated on a surface of a side of the first low-reflective membrane layer 30 away from the intermediate layer 20.

A thickness of the first low-reflective membrane layer 30 is 50-200 nm, and a thickness of the second low-reflective membrane layer 40 is also 50-200 nm. The thicknesses of the first low-reflective membrane layer 30 and the thicknesses of the second low-reflective membrane layer 40 may be the same or different, which may be adjusted according to the actual needs.

FIG. 2 illustrates a scanning electron microscope (SEM) surface morphology graph of the first low-reflective membrane layer 30. Specifically, the first low-reflective membrane layer 30 is prepared from spherical silica particles with a diameter of 50-150 nm, and the second reflective membrane layer 40 is also prepared from spherical particles of silica having a diameter of 50-150 nm. However, in the composite membrane layer structure 100 provided by the present application, the diameter of the silica spherical particles in the first low-reflective membrane layer 30 is larger than the diameter of the silica spherical particles in the second low-reflective membrane layer 40. The spherical particles of silica in the first low-reflective membrane layer 30 are large and thus have a small porosity factor, and the spherical particles of silica in the second low-reflective membrane layer 40 are small and thus have a large porosity factor, such that the porosity factor of the first low-reflective membrane layer 30 is less than the porosity factor of the second low-reflective membrane layer 40. The equivalent refractive index of the second low-reflective membrane layer 40 is less than the equivalent refractive index of the first low-reflective membrane layer 30. Specifically, the equivalent refractive index of the first low-reflective membrane layer 30 is n1 and the equivalent refractive index of the second low-reflective membrane layer 40 is n2, and it is satisfied that 1.15≤n1≤1.38 and 1.05≤n2≤1.15.

As shown in FIG. 3, the surface morphology graph of the membrane structure prepared by the aluminum oxide hydrolysis process on the surface of the lens in the related art is a grass-like structure, and the shape of the end of the particles is relatively sharp, so that significant scattering occurs when the light reaches the membrane structure, resulting in fogging during the actual shooting and affecting the image quality. FIG. 2 illustrates the SEM surface morphology graph of the first low-reflective membrane layer 30 of the present application, which shows that the silica spherical particles are relatively flat, so that the light scattering problem can be effectively solved to improve the quality of the image shooting.

It is understood that the substrate 10 is a resin lens, the raw material of which may be selected from one of APEL, EP, OKP, SP, and K26R. The intermediate layer 20 includes at least one of Ti₃O₅, H4, Nb₂O₅, HfO₂, L5 silicon-aluminum mixture, SiO₂, MgF₂, Al₂O₃.

Further, the present application also provides reflectivity data of the composite membrane layer structure 100 and the conventional AR film structure at Angles of Incidence (AOI) of 0°, 45°, and 60°, as shown in Table 1 below.

TABLE 1
Reflectivity of the composite membrane layer structure 100 of the
present application and the conventional AR membrane structure

| | R % | | | |
|---|---|---|---|---|
| | (380-980 nm) | AOI 0 | AOI 45 | AOI 60 |
| Conventional AR | Rmax % | 1.17 | 3.92 | 9.18 |
| membrane structure | Rave % | 0.33 | 1.48 | 5.36 |
| Composite membrane | Rmax % | 0.07 | 0.18 | 1.60 |
| layer structure | Rave % | 0.05 | 0.13 | 0.97 |

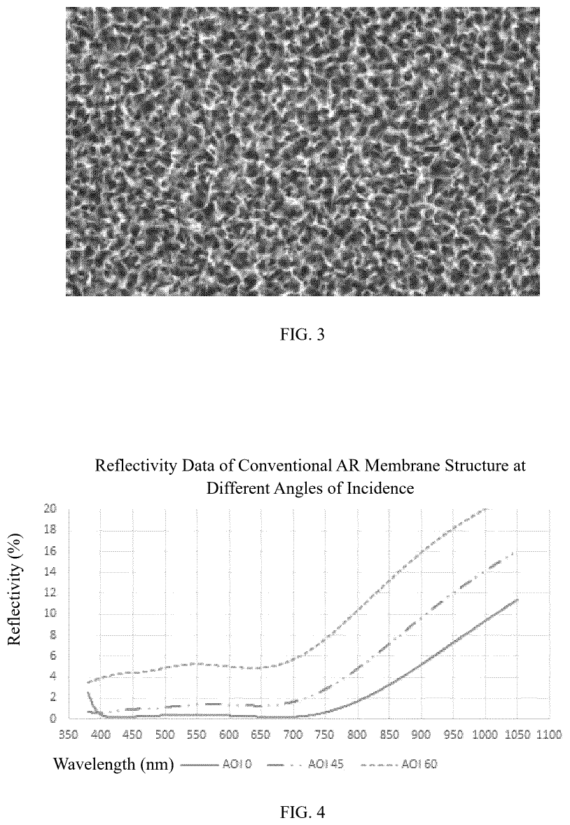

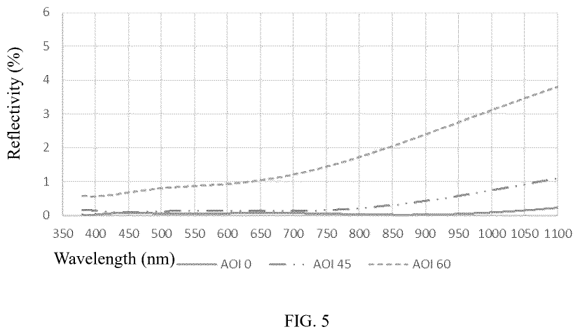

Combined with Table 1, FIG. 4, and FIG. 5 above, it can be seen that compared with the conventional AR film structure, the composite membrane layer structure 100 in the present application has a significant advantage in reflectivity. When the angle of incidence (AOI) of the light is 00, an average of reflectivity Rave of the composite membrane layer structure 100 in the 380-980 nm band is 0.05%, and the maximum value of the reflectivity Rmax is only 0.07%, which is lower than 0.1%, there is a very significant improvement compared with the conventional AR film structure. When the angle of incidence (AOI) of the light is 60°, an average of reflectivity Rave of the composite membrane layer structure 100 in the 380-980 nm band is 0.97%, which is less than one-fifth of that of the conventional AR film, so that the composite membrane layer structure 100 has significant advantages in optical properties.

In the present application, the reliability of the composite membrane layer structure 100 is further tested under the test conditions shown in Table 2 below.

TABLE 2
Reliability test conditions

| Test | High Temperature | High | Low | Thermal |
|---|---|---|---|---|
| Environment | and High Humidity | Temperature | Temperature | Shock |
| Test | 480 h | 480 h | 480 h | 480 h |
| Duration | | | | |
| Test | 85° C. ± 2° C. | 85° C. ± 2° C. | −40° C. ± 2° C. | 85° C. 30 min; |
| Condition | | | | −40° C. 30 min; |
| | | | | Circulate |
| | 85% ± 5% RH | / | / | / |

The composite membrane structure 100 provided by the present invention exhibits no peeling, cracking, or fogging phenomena under high temperature, high temperature and high humidity, low temperature, and thermal shock environments. It demonstrates excellent reliability, enabling users to maintain good image quality when using optical lenses equipped with this composite membrane structure in various extreme environments.

Compared to the related art, the composite membrane layer structure provided by the present application includes a substrate and an intermediate layer, a first low-reflective membrane layer, and a second low-reflective membrane layer sequentially coated on the substrate. An equivalent refractive index of the second low-reflective membrane layer is less than an equivalent refractive index of the first low-reflective membrane layer. An average value of reflectivity of the composite membrane layer structure is less than 0.1% in the 380-980 nm wavelength band at the angle of incidence of 0°, so that it has ultra-low reflectivity and low scattering characteristics, effectively solving the problem of fogging during actual shooting, and significantly improving the image quality.

Described above are only embodiments of the present application, and it should be pointed out that, for the ordinary technical personnel in the field, improvements can also be made without departing from the premise of the concept of the present application, but these are all within the protection scope of the present application.

What is claimed is:

1. A composite membrane layer structure, comprising:
a substrate;
an intermediate layer coated on the substrate;
a first low-reflective membrane layer coated on a surface of a side of the intermediate layer away from the substrate; and
a second low-reflective membrane layer coated on a surface of a side of the first low-reflective membrane layer away from the intermediate layer, wherein an equivalent refractive index of the second low-reflective membrane layer is less than an equivalent refractive index of the first low-reflective membrane layer.

2. The composite membrane layer structure of claim 1, wherein the equivalent refractive index of the first low-reflective membrane layer is n1, and the equivalent refractive index of the second low-reflective membrane layer is n2, wherein 1.15≤n1≤1.38 and 1.05≤n2≤1.15.

3. The composite membrane layer structure of claim 1, wherein a thickness of the first low-reflective membrane layer and a thickness of the second low-reflective membrane layer are both 50-200 nm.

4. The composite membrane layer structure of claim 1, wherein the first low-reflective membrane layer and the second reflective membrane layer both comprise silica spherical particles having a diameter of 50-150 nm, wherein a diameter of the silica spherical particles in the first low-reflective membrane layer is greater than a diameter of the silica spherical particles in the second low-reflective membrane layer, and a porosity factor of the first low-reflective membrane layer is less than a porosity factor of the second low-reflective membrane layer.

5. The composite membrane layer structure of claim 1, wherein the substrate is a resin lens.

6. The composite membrane layer structure of claim 1, wherein the intermediate layer comprises at least one of Ti₃O₅, H4, Nb₂O₅, HfO₂, L5 silicon-aluminum mixture, SiO₂, MgF₂, Al₂O₃.
